(19) United States
(12) Patent Application Publication
(10) Pub. No.: US 2007/0240185 A1
(43) Pub. Date: Oct. 11, 2007

(54) Methods, apparatuses, and computer program products for delivering audio content on demand

(76) Inventor: Timothy H. Weaver, Alpharetta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/510,983

(22) Filed: Aug. 28, 2006

Related U.S. Application Data
(60) Provisional application No. 60/711,884, filed on Aug. 26, 2005.

(51) Int. Cl. H04N 7/173; G06F 13/00; H04N 5/445

(52) U.S. Cl. 725/39; 725/86; 725/87

(57) ABSTRACT

Methods, apparatuses, and computer program products for delivering audio content on demand. The methods include receiving a plurality of packets from a network, each of the packets bearing a multicast or unicast identifier corresponding to an item of audio content. The plurality of packets are stored secured from a listener on a service provider controlled partition of a local storage device. If a listener input is received indicative of the listener purchasing a right to play the item of audio content, downloading of the stored plurality of packets to a media presentation device is enabled.

### RELATED CASES

This application is based upon and claims priority under 35 USC §119(e) to Provisional Patent Application Ser. No. 60/711,884 filed on Aug. 26, 2005, the disclosure of which is incorporated herein in its entirety.

### BACKGROUND OF THE INVENTION

The present invention relates generally to delivery of audio content in connection with a wide area data network and, more particularly, to methods, apparatuses, and computer program products for delivering audio content on demand.

Delivering audio content over a wide area data network is an increasingly popular method of transmitting music and audio programs to listeners, enabling service providers to offer programming more efficiently than in the case of many other delivery systems. Internet protocol television (IPTV) represents one illustrative approach for delivering audio content over a network. IPTV is ideal for musical selections and audio programs intended for use by one, two, or a relatively small number of subscribers, because a minimum amount of network resources are tied up to service this need. In contrast to terrestrial broadcast radio and satellite radio, IPTV has no inherent limitation on the total number of channels that can be offered for transmission. As a practical matter, the number of channels that can be carried to IPTV subscribers is significantly higher relative to traditional audio delivery systems, limited only by the overall capacity of the network and the portion of the network which is allocated to IPTV services. Moreover, the same data transmission capacity of a network can be used for IPTV as well as other types of data traffic. IPTV sends audio and audiovisual information over the network in the form of packet streams.

Wide area data networks may be used to provide customers with broadcast audio programs including those carried by over-the-air broadcast stations and cable channels. They can also be used to provide subscribers with access to audio-on-demand programs. Existing methods for delivering audio-on-demand and audio programs do not utilize the network in an efficient manner. These methods establish a unique audio stream for each customer listening to an audio-on-demand selection, including those listeners who are listening to the selection at the same time. Because the wide area data network is called upon to deliver both audio and video programming to customers during periods of peak usage, significant demands are placed on the wide area data network in terms of bandwidth and operational capacity during such periods. Since wide area data networks must be designed to deliver acceptable service quality during periods of heavy usage, the cost of providing audio-on-demand services in this manner is unnecessarily high.

During periods of heavy audio-on-demand usage, the wide area data network may become congested, with the effect that packet throughput slows down, possibly interrupting the continuity of a program in progress, or making it necessary to deny service to a customer requesting an audio-on-demand program. In addition, the aggregate last mile network bandwidth required to deliver broadcast audio channels and audio-on-demand programs to some customers may, at times, exceed the total amount of bandwidth available, making it necessary to deny services to some customers during peak periods. By contrast, network utilization may be quite low during other time periods, such as 12:00 midnight to 4:00 AM, with the network having excess capacity that remains dormant. Existing approaches to delivering audio-on-demand services do not efficiently utilize network capacity and do not exploit the unique capabilities of IPTV networks and current customer premises technology. They do not consider current levels of network utilization and, instead, automatically initiate delivery of a musical selection on request even if the network is already operating at or near capacity. Accordingly, what is needed is a technique for delivering audio-on-demand programs which increases network utilization efficiency relative to presently existing techniques and provides a choice of audio-on-demand delivery options to satisfy customer demand during peak usage periods.

### BRIEF SUMMARY OF THE INVENTION

Exemplary embodiments include methods for delivering audio content on demand. These methods comprise receiving a selection of audio content for listening on demand; receiving an input specifying delayed listening; determining that the audio content is to commence before expiration of a predetermined time interval; determining whether or not any inputs from other listeners have been received that also specify delayed listening to the same audio content before expiration of the predetermined time interval; and if no such inputs from other listeners are received, then requesting a plurality of packets from the network, each of the packets bearing a unicast identifier corresponding to the selected audio content; otherwise, requesting a plurality of packets from the network, each of the packets bearing a multicast identifier corresponding to the selected audio content; receiving the plurality of packets; and delivering the plurality of packets for presentation of the audio content.

Other exemplary embodiments include methods for delivering listening-on-demand audio content. These methods comprise receiving a selection of audio content for listening on demand; receiving an input specifying deferred listening; determining that network utilization is less than a peak network utilization; requesting the audio content; receiving the audio content; and delivering the audio content to a destination.

Other exemplary embodiments include computer program products for facilitating delivery of on demand audio content. The computer program products comprise instructions for presenting an offer to select the audio content; presenting options for at least two of: immediate listening, delayed listening, and deferred listening; receiving a selection of audio content for listening; receiving an input specifying one of: immediate listening, delayed listening, or deferred listening; sending a request for the audio content, wherein the request includes an indication of the input specified; and receiving the audio content.

Other methods, apparatuses, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of an exemplary system that may be utilized for delivering audio content on demand.

FIGS. 2A-2D together comprise a flow diagram of a first exemplary process for delivering audio content on demand.

FIG. 3 is a flow diagram of a second exemplary process for delivering audio content on demand.

The detailed description explains the exemplary embodiments, together with advantages and features, by way of example with reference to the drawings.

### DETAILED DESCRIPTION OF EXEMPLARY EMBODIMENTS

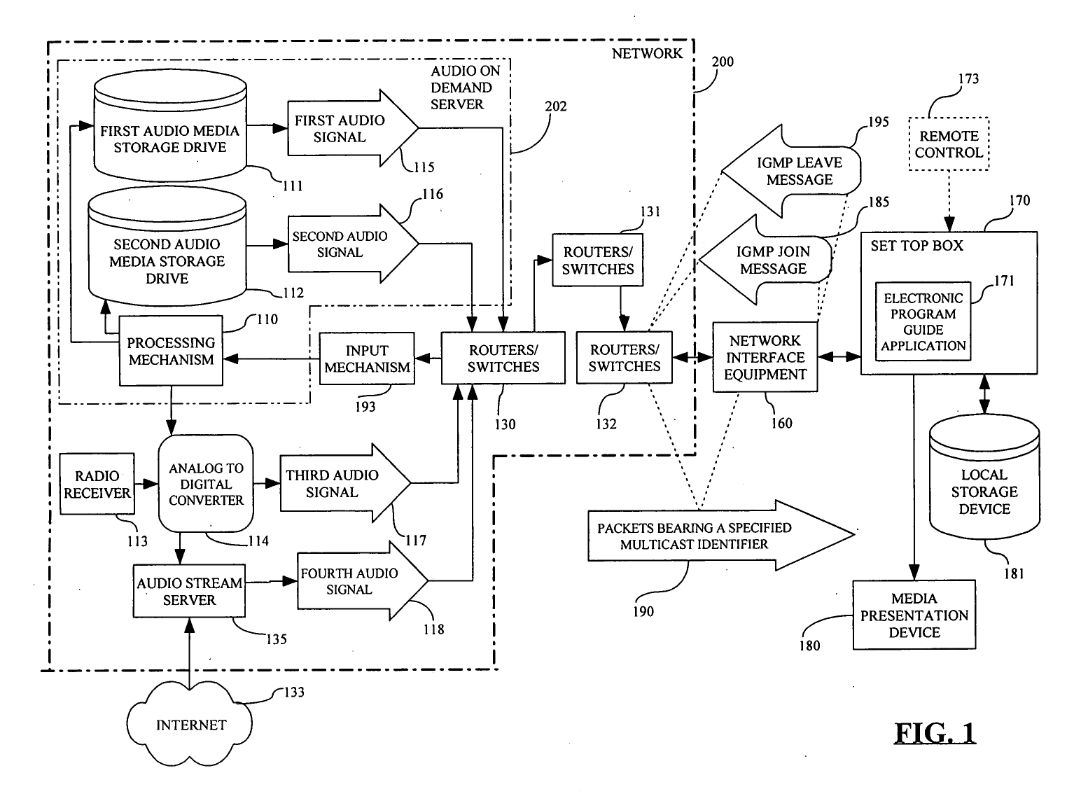

FIG. 1 is a block diagram of an exemplary system that may be utilized for delivering audio content on demand. A wide area data network 200 includes an audio-on-demand server 202 associated with one or more audio media storage drives capable of electronically storing items of audio content for subsequent transmission to one or more listeners. In the present example, audio-on-demand server 202 includes a first audio media storage drive 111, a second audio media storage drive 112, and a processing mechanism 110 capable of accessing first audio media storage drive 111 and second audio media storage drive 112. Audio-on-demand server 202 is capable of generating at least one program stream in the form of a unicast program stream, a multicast program stream, a plurality of multicast or unicast program streams, or various combinations thereof.

Audio-on-demand server 202 is shown as including first and second audio media storage drives 111 and 112 and processing mechanism 110 for purposes of illustration. One or more of first audio media storage drive 111, second audio media storage drives 112, or processing mechanism 110 could be external to audio-on-demand server 202. Optionally, processing mechanism 110 may be implemented using a plurality of processors, one or more of which is internal to audio-on-demand server 202, and one or more of which is external to audio-on-demand server 202. A plurality of separate storage drives may be interconnected or networked to implement first audio media storage drive 111, or the first and second audio media storage drives 111, 112 may be combined into a single integrated audio media storage drive. Moreover, use of two audio media storage drives is not required, as any number of one or more audio media storage drives can be employed. First and second audio media storage drives 111, 112 are each illustratively implemented using one or more computer hard drives, optical storage drives, magnetic tape drives, semiconductor memory, nanotechnology-based memory devices, or various combinations thereof.

Processing mechanism 110 accesses first audio media storage drive 111 to generate a first audio signal 115 including a first item of audio content. Processing mechanism 110 accesses second audio media storage drive 112 to generate a second audio signal 116 including a second item of audio content.

A radio receiver 113 receives one or more terrestrial radio broadcasts, satellite radio broadcasts, or both. The one or more radio broadcasts are fed to respective inputs of an analog to digital converter 114, which converts each radio broadcast into a corresponding digital program stream. Radio receiver 113 and analog to digital converter 114 could, but need not, be combined into a single element. In the present example, analog to digital converter 114 provides a third audio signal 117 that includes a digital program stream. Optionally, the digital program stream could be stored in a audio media storage drive for delayed broadcast or, as shown in FIG. 1, transmitted over network 200 for live broadcast, or both. The operation of analog to digital converter 114 is controlled by processing mechanism 110 which, as stated above, can be internal to audio-on-demand server 202, external to audio-on-demand server 202, or both.

Network 200 is capable of accessing the Internet 133 by means of an audio stream server 135. Audio stream server 135 accesses one or more audio streams from one or more Internet web sites that provide live radio broadcasts, audio programming on demand, or both. In the example of FIG. 1, audio stream server 135 provides a fourth audio signal 118 representing the one or more audio streams. Audio stream server 135 is illustratively implemented using a computer server. Illustratively, audio-on-demand server 202 and audio stream server 135 may be implemented using a single server. Pursuant to another illustrative example, audio-on-demand server 202 and audio stream server 135 are each implemented using a plurality of servers.

Respective first, second, third and fourth audio signals 115, 116, 117 and 118 each include a corresponding sequence of packets in a digital format compatible with internet protocol (IP) networking. In other words, first, second, third, and fourth audio signals 115, 116, 117 and 118 may each represent a sequence of packets. Illustratively, the sequence of packets represented by first, second, third, and fourth audio signals 115, 116, 117, and 118 are each in a packetized format that complies with MPEG-4 standard H.264. Optionally, at least one of first, second, third, and fourth audio signals 115, 116, 117, and 118 also includes video information in the form of still or moving graphics, still or moving images, or both.

Processing mechanism 110 is capable of accepting input from an input mechanism 193. Input mechanism 193 could, but need not, be implemented using a modem, data receiver, computer keyboard, touch screen, pushbuttons, one or more switches, voice-activated software, personal computer, computer server, mainframe computer, laptop computer, computer console, or various combinations thereof. In practice, input mechanism 193 could, but need not, be combined with processing mechanism 110 such that input mechanism 193 and processing mechanism 110 are implemented by a single element such as a server, personal computer, or other device.

Input mechanism 193 is responsive to input from a system operator to control audio-on-demand server 202 and audio stream server 135. This operator input may provide one or more rules for controlling audio-on-demand server 202 and audio stream server 135 to reflect one or more operator policies.

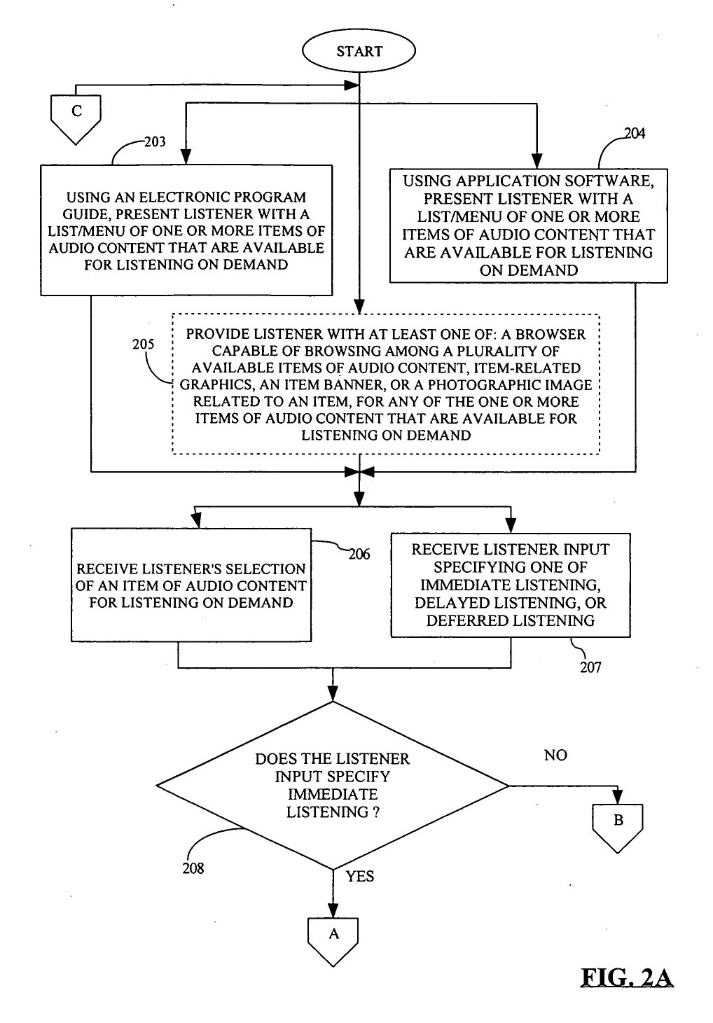

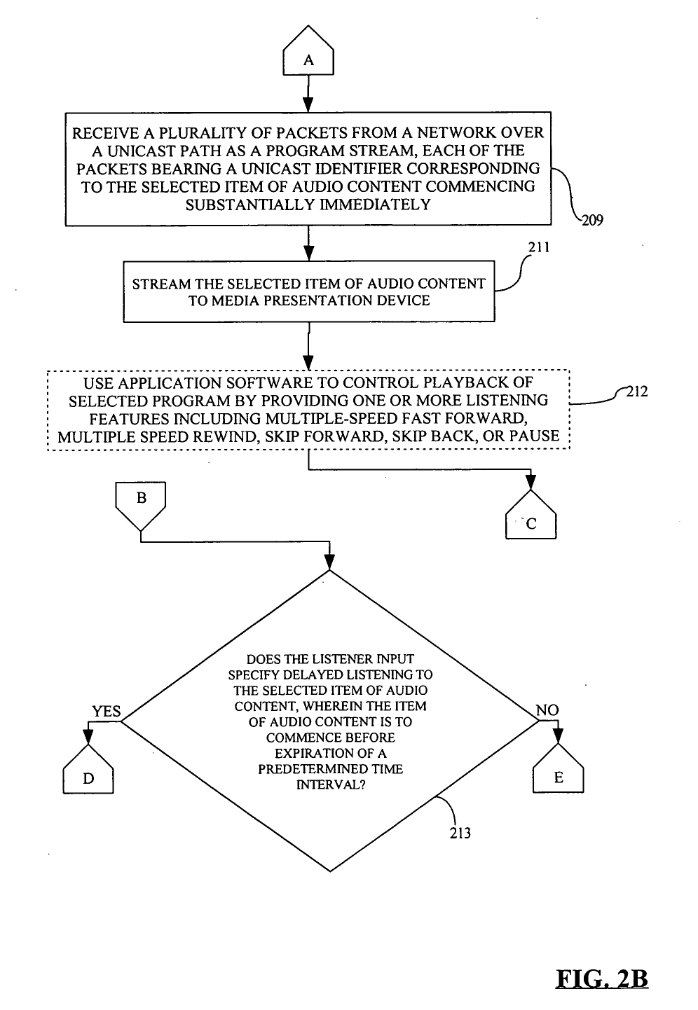

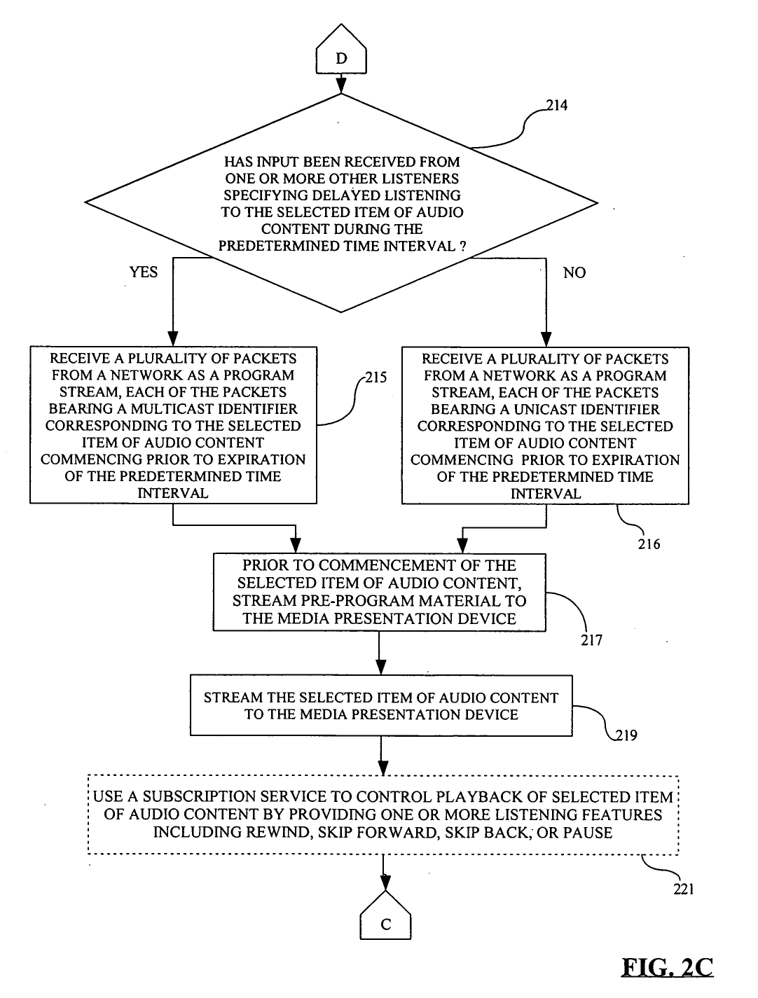

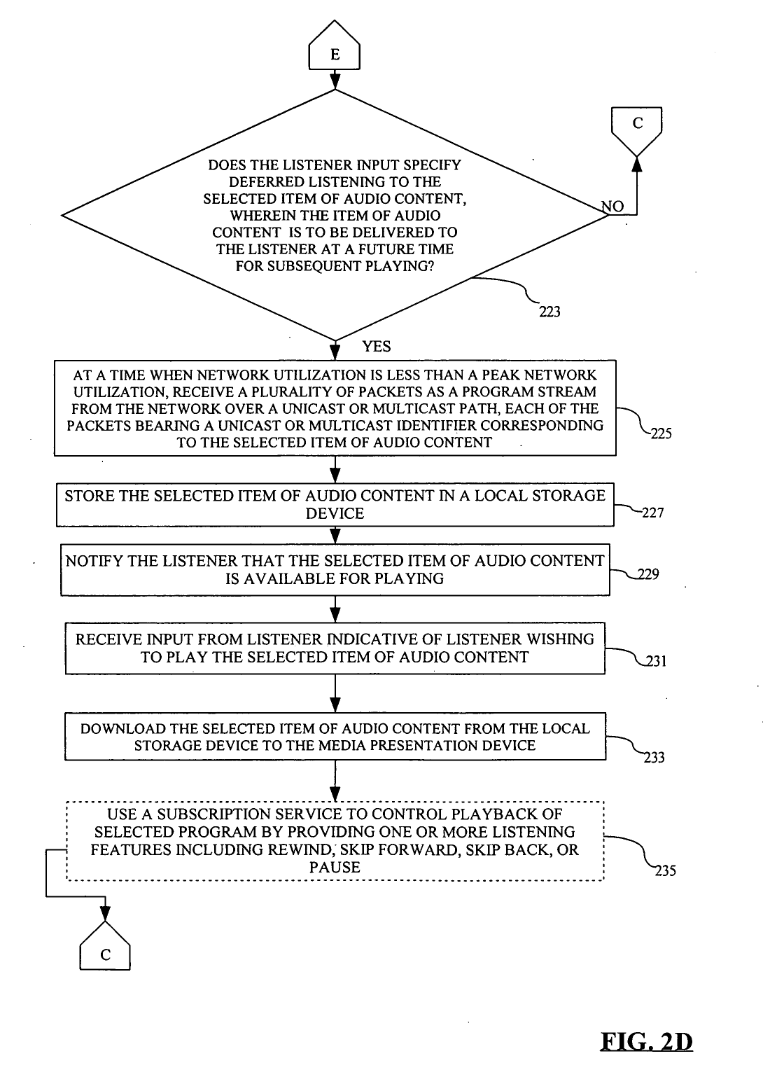

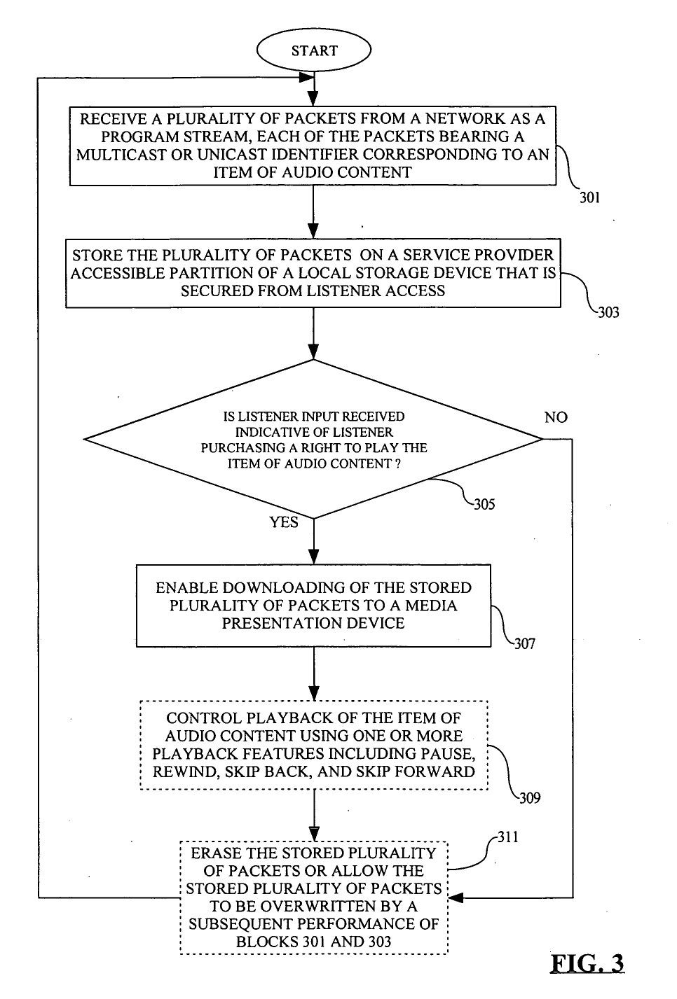

Input mechanism 193 is responsive to a listener input received from an electronic program guide application 171 (to be described in greater detail hereinafter) and transmitted over routers/switches 132, 131, 130 via network interface equipment 160. This listener input represents a request for on-demand listening of an item of audio content selected using electronic program guide application 171. The listener input also specifies one of immediate listening, delayed listening, or deferred listening (to be described in greater detail hereinafter with reference to FIGS. 2A-2D and 3). In response to input received at input mechanism 193 (FIG. 1), processing mechanism 110 may command any of audio-on-demand server 202, audio stream server 135, or analog to digital converter 114 to access a respective item of audio content from any of the first audio media storage drive 111, second audio media storage drive 112, radio receiver 113, or Internet 133, to generate a corresponding audio signal such as first, second, third or fourth audio signal 115, 116, 117, or 118 including the respective item of audio content.

By way of example, a listener selects immediate listening of a first item of audio content using electronic program guide application 171. This selection is received by network interface equipment 160, routers 132, 131, 130, input mechanism 193, and processing mechanism 110. In response to receipt of the listener selection, processing mechanism 110 commands audio-on-demand server 202 to access the first item of audio content which is stored on first audio media storage drive 111. Audio-on-demand server 202 generates a first multicast program stream in the form of first audio signal 115. First audio signal 115 includes the first item of audio content.

Illustratively, in response to additional listener selections received at input mechanism 193, processing mechanism 110 may command audio-on-demand server 202 to access a second item of audio content stored on second audio media storage drive 112 to generate a second multicast program stream in the form of second audio signal 116 including the second item of audio content. In this example, the first and second items of audio content are audio-on-demand selections, voice programs, or various combinations thereof. Similarly, in response to additional listener selections received at input mechanism 193, processing mechanism 110 may command analog to digital converter 114 to access a third item of audio content from radio receiver 113 in the form of third audio signal 117 including the third item of audio content. The third item of audio content is a terrestrial or satellite radio broadcast station.

In response to another listener selection received at input mechanism 193, processing mechanism 110 commands audio stream server 134 to access a fourth item of audio content from the Internet 133 and to generate a fourth audio signal 118 including the fourth item of audio content. The fourth item of audio content includes an Internet broadcast station. Accordingly, first, second, third and fourth audiovisual signals 115, 116, 117, and 118m each representing streams of individual packets corresponding to respective first, second, and third multicast program streams pass through a series of routers/switches 130, 131, 132 until one or more of the streams reaches a listener's location. First, second, third and fourth audio signals 115, 116, 117 and 118 are described only for purposes of illustration, it being understood that three signals are not required, as any number of one or more audio signals may be provided, and these one or more signals may optionally include video information in addition to audio information.

At a listener's location, network interface equipment 160 receives one of the first, second, third and fourth multicast program streams from router/switch 132 on network 200. Network interface equipment 160 is operatively coupled to a set top box 170 using a wireless or wireline link and, illustratively, using an Ethernet link. Set top box 170 is operatively coupled to a media presentation device 180, such as a radio, television set, audiovisual receiver, or the like using a wireless or wireline link and, illustratively, using coaxial cable carrying an RF-modulated signal. Alternatively or additionally, set top box 170 is coupled to media presentation device using a video connection such as S-Video or FireWire.

Set top box 170 is equipped with a processing mechanism, such as a microprocessor or microcontroller and associated semiconductor memory, for executing electronic program guide application 171. Electronic program guide application 171 causes media presentation device 180 to display an electronic program guide in the form of a list or menu of one or more items of audio content available for listening on demand. Optionally, electronic program guide 171 may list one or more audio channels in addition to listing programs that are available for listening on demand, wherein the one or more audio channels offer audio programs associated with one or more corresponding scheduled broadcast times or one or more live broadcast channels. Set top box 170 includes a channel/program selection mechanism capable of accepting a listener input identifying one or more items of audio content for listening on demand. This channel/program selection mechanism could, but need not, operate in conjunction with electronic program guide application 171, for example using optional remote control 173 or a touch-sensitive screen on media presentation device 180 to select a displayed item of audio content or audio channel from the displayed electronic program guide. Alternatively or additionally, set top box 170 may include an item/channel/program selection mechanism such as a rotary switch and/or an item/channel/program selection mechanism operated using an optional remote control 173. Set top box 170 may, but need not, include circuitry for converting digital packets representing program streams received from network interface equipment 160 into analog or digital signals capable of being played back in audible form by media presentation device 180.

If a listener requests deferred listening to an item of audio content (to be described in greater detail with reference to FIGS. 2A-2D and 3), network 200 may download the item of audio content to network interface equipment 160 during a time when network usage is expected to be relatively low compared to a period of peak network usage. A local storage device 181 receives the downloaded item of audio content from network interface equipment 160. The downloaded item of audio content is stored on a service-provider controlled portion of local storage device 181 for subsequent listening. Local storage device 181 may be implemented using a digital video disc (DVD) recorder, videocassette recorder (VCR), audio cassette recorder, IPOD device, or hard drive recording device. Local storage device 181 is partitioned such that a first portion of local storage device 181 is listener accessible, whereas a second portion of local storage device 181 is secured from the listener. The second portion of local storage device 181 is accessed by a service provider over network 200. Upon receipt of a listener request to access an item of audio content stored in the second portion of local storage device 181, the service provider may enable listener access to this stored item of audio content for listening on media presentation device 180. Local storage device 181 may, but need not, be integrated into set top box 170. Moreover, set top box 170 may, but need not, be integrated into media presentation device 180.

Network interface equipment 160 receives a stream of internet protocol (IP) multicast or unicast packets representing a program stream for an item of audio content. The item of audio content may include any of an audio-on-demand selection, a live audio broadcast, a stored audio broadcast, or various combinations thereof. Unicast refers to communication between a single sender and a single receiver, whereas multicast refers to communication between a single sender and multiple receivers. To avoid sending a multiplicity of different program streams simultaneously over network 200, each respective program stream uses a corresponding IP multicast identifier specific to that program stream. Using Internet Group Management Protocol (IGMP), network interface equipment 160 communicates with network 200 to identify which item of audio content the user desires to listen to, or which item of audio content the listener is currently listening to. For example, when a listener enters an input into the channel/program selection mechanism on set top box 170, illustratively using an optional remote control 173 to select immediate listening of a specified on-demand item of audio content, set top box 170 transmits an IGMP join message 185 to the network 200.

IGMP join message 185 includes an item/channel/program identifier that identifies an item of audio content that the listener desires to listen to, or an item of audio content that the listener is currently listening to. IGMP join message 185 is sent in an “upstream” direction through routers/switches 132, 131, 130 in an attempt to locate a program stream on network 200 corresponding to the item/channel/program identifier. When the appropriate program stream is located, packets bearing a specified multicast identifier 190 for this stream are transmitted in a “downstream” direction from network 200 to network interface equipment 160 and set top box 170. Set top box 170 then relays the program stream to media presentation device 180, such as a program stream representing first audio signal 115 and carrying a first item of audio content for listening on demand. Thereafter, when the user enters an input into the item/channel/program selection mechanism on set top box 170 indicating that he or she wishes immediate listening of a second item of audio content available for listening on demand, set top box 170 transmits an IGMP leave message 195 to network 200 identifying the first item of audio content, and transmits an IGMP join message 185 to the network 200 identifying the second item of audio content.

As understood by one of ordinary skill in the relevant art, if a program is intended for one and only one subscriber, multicasting is replaced by unicasting. Both multicasting and unicasting fall within the scope of the instant teaching. An example of a unicast program would be an on-demand item of audio content requested for immediate listening by only one listener, which by definition is intended for one and only one user destination.

FIGS. 2A-2D together comprise a flow diagram of a first exemplary process for delivering audio content on demand. Blocks 203, 204, and 205 (FIG. 2A) may be performed in any order or simultaneously. However, in an embodiment of the present invention, performance of all three blocks 203, 204, 205 is not required as, at a minimum, it is only necessary to perform one of the three blocks 203, 204 or 205. At block 203, using electronic program guide 170 (FIG. 1), a listener is presented with a list or menu of one or more items of audio content that are available for listening on demand. At block 204 (FIG. 2A), using application software running on set top box 170 (FIG. 1) or other customer premises equipment, a listener is presented with a list or menu of one or more items of audio content that are available for listening on demand. At block 205 (FIG. 2A), a listener is provided with at least one of a browser capable of browsing among a plurality of available items of audio content, an item preview, an item banner, or a picture-in-picture image of an item preview or a banner, for any of one or more items of audio content that are available for listening on demand.

After at least one of blocks 203, 204 and 205 have been executed, the process advances to blocks 206 and 207. Blocks 206 and 207 can be performed simultaneously or in any order. At block 206, a listener's selection is received of an item of audio content for listening on demand. Illustratively, this selection can be received as an item selected from a list or menu, or by the listener clicking on or touching a program related graphic, banner, or photographic image. At block 207, a listener input is received specifying one of immediate listening, delayed listening, or deferred listening to an item of audio content available for listening on demand. Optionally, blocks 206 and 207 may be combined into a single step as, for example, if a first menu or list is provided for items of audio content that are available for immediate listening, a second menu or list is provided for items of audio content that are available for delayed listening, and a third menu or list is provided for items of audio content that are available for deferred listening. As one exemplary alternative to using separate menus or lists, a single menu or list may be employed where items that are available for immediate listening are shown in a first color or associated with a first graphical icon (or both), with items that are available for deferred listening being shown using a second color or second graphical icon or both, and items that are available for delayed listening being shown using a third color or a third graphical icon or both.

A test is performed at block 208 to ascertain whether or not the listener input specifies immediate listening. If so, the process advances to block 209 (FIG. 2B) where a plurality of packets are received from network 200 (FIG. 1) as a program stream over a unicast path. Each of the packets bears a unicast identifier corresponding to the selected item of audio content commencing substantially immediately. Next, at block 211 (FIG. 2B), the selected item of audio content is streamed to media presentation device 180 (FIG. 1). Optionally, application software executed by set top box 170 or another item of customer premises equipment (not shown) is used to control playback of the selected program by providing one or more listening features including at least one of multiple-speed fast forward, multiple-speed rewind, skip forward, skip back, or pause (FIG. 2B, block 212).

The negative branch from block 208 (FIG. 2A) leads to block 213 (FIG. 2B) where a test is performed to ascertain whether or not the listener input specifies delayed listening to the selected item of audio content, wherein the item of audio content is to commence before expiration of a predetermined time interval. If so, the process advances to block 214 (FIG. 2C) where another test is performed to determine whether or not any inputs from one or more additional listeners have been received during the predetermined time interval that also specify delayed listening to the same listener selected item of audio content as was previously described in connection with block 206. If not, the process advances to block 216 where a plurality of packets are received from the network as a program stream, each of the packets bearing a unicast identifier corresponding to the selected item of audio content commencing prior to expiration of the predetermined time interval. The process then progresses to block 217, to be described in greater detail hereinafter.

The affirmative branch from block 214 leads to block 215 where a plurality of packets are received from the network as a program stream, each of the packets bearing a multicast identifier corresponding to the selected item of audio content commencing prior to expiration of the predetermined time interval. The process advances to block 217 where, prior to commencement of the selected item of audio content, pre-program material is streamed to the media presentation device. The selected item of audio content is then streamed to the media presentation device wherein the streaming commences prior to expiration of the predetermined time interval (block 219). Optionally, a subscription service may be employed to control playback of the selected item of audio content by providing one or more listening features including rewind, skip forward, skip back, or pause (block 221). Optionally, the selected item of audio content includes video information in the form of still or moving graphics, still or moving images, or both.

The negative branch from block 213 (FIG. 2B) leads to block 223 (FIG. 2D) where a test is performed to determine whether or not the listener input specifies deferred listening to the selected item of audio content, wherein the item of audio content is delivered to the listener at a future time for subsequent listening. If not, the process loops back to any of blocks 203, 204, or 205 (FIG. 2A) discussed previously. The affirmative branch from block 223 (FIG. 2D) leads to block 225 where, at a time when network utilization is expected to be relatively low compared with one or more peak periods of network utilization, a plurality of packets are received from the network as a program stream over a unicast or multicast path, each of the packets bearing a unicast or multicast identifier corresponding to the selected item of audio content.

At block 227, the selected item of audio content is stored in local storage device 181 (FIG. 1), and the listener is notified that the selected item of audio content is available for listening (FIG. 2D, block 229). Illustratively, block 229 may be performed by transmitting a notification signal over network 200 (FIG. 1) to network interface equipment 160, set top box 170, and media presentation device 180, causing a visual or audible or audiovisual indication to be rendered by media presentation device 180. For example, a semi-transparent icon appearing in a corner of an electronic display screen of media presentation device 180 could, but need not, be used as a suitable visual indication that the selected program is available for playback.

Next, at block 231 (FIG. 2D), input from the listener is received (for example, using optional remote control 173 of FIG. 1) indicative of the listener wishing to listen to the selected item of audio content. The selected item of audio content is downloaded from the local storage device to the media presentation device (FIG. 2D, block 233). Optionally, a subscription service may be employed to control playback of the selected program by providing one or more listening features including rewind, skip forward, skip back, or pause (block 235). The process then loops back to any of blocks 203, 204, or 205 (FIG. 2A) described previously.

FIG. 3 is a flow diagram of a second exemplary process for delivering audio content on demand. The process commences at block 301 where a plurality of packets are received from network 200 (FIG. 1) as a program stream, each of the packets bearing a multicast or unicast identifier corresponding to an item of audio content. Next (FIG. 3, block 303), the plurality of packets are stored secured from a listener on a service provider controlled partition of local storage device 181 (FIG. 1). The plurality of packets are secured from the listener in the sense that the listener cannot initiate playback of the plurality of packets at will unless playback is subsequently enabled by the service provider over the network.

At block 305 (FIG. 3), a test is performed to ascertain whether or not a listener input is received indicative of the listener purchasing a right to listen to the item of audio content. If so, downloading of the stored plurality of packets to media presentation device 180 (FIG. 1) is enabled at block 307 (FIG. 3), wherein the stored plurality of packets represent the item of audio content. Optionally, playback of the downloaded item of audio content is controlled (block 309) using one or more playback features including pause, rewind, skip back, and skip forward. Next, at optional block 311, the stored plurality of packets are erased or the stored plurality of packets are allowed to be overwritten by a subsequent performance of blocks 301 and 303. The plurality of packets may be erased by means of a service provider command sent over network 200 (FIG. 1) and received by network interface equipment 160. After block 311 (FIG. 3), the process loops back to block 301. The negative branch from block 305 also leads back to block 301.

The detailed description explains various exemplary embodiments, together with advantages and features, by way of example with reference to the drawings. As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for delivering on demand audio content, the method comprising:
receiving a selection of audio content for listening on demand;
receiving an input specifying delayed listening;
determining that the audio content is to commence before expiration of a predetermined time interval;
determining whether or not any inputs from other listeners have been received that also specify delayed listening of the same audio content before expiration of the predetermined time interval and;
if no such inputs from other listeners are received, then requesting a plurality of packets from the network, each of the packets bearing a unicast identifier corresponding to the selected audio content;
otherwise, requesting a plurality of packets from the network, each of the packets bearing a multicast identifier corresponding to the selected audio content;
receiving the plurality of packets; and
delivering the plurality of packets for presentation of the audio content.

2. The method of claim 1 wherein delivering the plurality of packets includes streaming the plurality of packets to a media presentation device.

3. The method of claim 2 wherein streaming the plurality of packets includes streaming pre-program material to the media presentation device.

4. The method of claim 3 wherein the pre-program material includes any of: an advertisement, an informational announcement, a coming attraction, a graphical display, a pictorial display, musical programming, a corporate logo, or various combinations thereof.

5. A method for delivering on demand audio content, the method comprising:
receiving a selection of audio content for listening on demand;
receiving an input specifying deferred listening;
determining that network utilization is less than a peak network utilization;
requesting the audio content;
receiving the audio content; and
delivering the audio content to a destination.

6. The method of claim 5 further including storing the audio content in a local storage device.

7. The method of claim 6 wherein the stored audio content includes pre-program material comprising any of: an advertisement, an informational announcement, a coming attraction, a graphical display, a pictorial display, musical programming, a corporate logo, or various combinations thereof.

8. The method of claim 6 further including providing a notification to the listener that the selected audio content is available for playing.

9. A computer program product for facilitating delivery of on demand audio content, comprising instructions for:
presenting an offer to select the audio content;
presenting options for at least two of: immediate listening, delayed listening, and deferred listening;
receiving a selection of audio content for listening;
receiving an input specifying one of: immediate listening, delayed listening, or deferred listening;
sending a request for the audio content, wherein the request includes an indication of the input specified; and
receiving the audio content.

10. The computer program product of claim 9 further comprising instructions for receiving a plurality of packets from a network over a unicast path if the listener input specifies immediate listening, each of the packets bearing a unicast identifier corresponding to the listener selected audio content commencing substantially immediately.

11. The computer program product of claim 9 further comprising instructions for determining whether or not any inputs from other listeners have been received that also specify delayed listening of the listener selected media content within the predetermined time interval if the listener input specifies delayed listening to the selected audio content such that the audio content is to commence before expiration of a predetermined time interval.

12. The computer program product of claim 11 further comprising instructions for receiving a plurality of packets from the network if no input from other listeners has been received that specifies delayed listening, wherein each of the packets bears a unicast identifier corresponding to the selected audio content commencing before expiration of a predetermined time interval.

13. The computer program product of claim 11 further comprising instructions for receiving a plurality of packets from the network if at least one input from another listener has been received that specifies delayed listening, wherein each of the packets bears a multicast identifier corresponding to the selected audio content commencing before expiration of a predetermined time interval.

14. The computer program product of claim 9 wherein, if the listener input specifies deferred listening of the selected audio content wherein the audio content is delivered to the listener at a future time for subsequent listening, then the computer program product further comprises instructions for receiving a plurality of packets from the network over a unicast or multicast path at a time when network utilization is less than a peak network utilization, each of the packets bearing a unicast or multicast identifier corresponding to the selected audio content.

15. The computer program product of claim 14 further comprising instructions for storing the selected audio content in a local storage device.

16. The computer program product of claim 15 further comprising instructions for providing a notification to the listener that the selected audio content is available for listening.

17. The computer program product of claim 16 further including instructions for erasing the stored plurality of packets if a listener input is not received indicative of the listener purchasing a right to listen to the selected audio content.

18. The computer program product of claim 16 further including instructions for allowing the stored plurality of packets to be overwritten by a subsequent storing of a plurality of packets if a listener input is not received indicative of the listener purchasing a right to listen to the selected audio content.

19. The computer program product of claim 9 wherein the received audio content includes pre-program material.

20. The computer program product of claim 19 wherein the pre-program material includes any of: an advertisement, an informational announcement, a coming attraction, a graphical display, a pictorial display, musical programming, a corporate logo, or various combinations thereof.
